(19) United States
(12) Patent Application Publication
(10) Pub. No.: US 2008/0190377 A1
(43) Pub. Date: Aug. 14, 2008

(54) HORIZONTAL EXERCISE AND SCRATCHING BEAM FOR FELINES

(76) Inventor: Nell Boone Clowder, Austin, TX (US)

Correspondence Address: Nell Clowder, 14001 Trail Driver St., Austin, TX, 78737, US

(21) Appl. No.: 11/620,698

(22) Filed: Feb. 12, 2007

(51) Int. Cl. A01K 15/02

(52) U.S. Cl. 119/706

(57) ABSTRACT

An exercise and scratching device for felines comprising a beam and a plurality of vertical support members. The beam is supported by the vertical members in a substantially horizontal orientation and at such a height from the supporting surface that an average-sized housecat can lie on its back beneath the beam, grasp the beam with its feet or claws, and pull itself along on its back for the full length of the beam. Embodiments present either the beam or a beam wrapping as a surface on which cats can sharpen their claws. Other embodiments add feet, and/or a neck and head to enhance the resemblance of the device to an animal.

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BACKGROUND

1. Field of Invention

This invention relates to feline climbing, scratching and exercise devices, and more particularly concerns an exercise and scratching device having a primarily horizontal orientation which facilitates a feline dragging itself playfully along the floor on its back.

2. Prior Art

Climbing and scratching devices to provide domestic cats with exercise and an appropriate object upon which to sharpen their claws have been known and used for some time. Many such devices have a primarily vertical orientation to allow the cat to duplicate naturally occurring behaviors, such as climbing trees and sharpening claws on the trunks of trees, within a domestic environment. Such vertically oriented devices do not provide cats with a suitable structure to engage in another ordinary feline behavior, namely: assuming an upside-down posture. An upside-down (on the back) posture is commonly used by cats when fighting or playing with another animal or cat. In this upside-down posture, a cat will use its claws to grasp low-lying structures and drag itself along the floor on its back (back-dragging), a behavior which may be observed in households where there are sofas which present a long surface near the floor but not too close to the floor.

In addition, vertically oriented devices may not be accessible or safe for older cats or cats with infirmities. Some pet owners will not use such devices even for a healthy cat, because the high perches and/or climbing surfaces present a hazard of the cat falling, or because they are too large for the owner's household. The challenge of creating a device which is a) safe for older or infirm cats, b) attractive and stimulating to all cats, c) equipped with a scratchable surface and, because of the combination of these features d) will attract cats away cat from scratching on inappropriate household items-this challenge remains imperfectly solved by the prior art.

Devices or structures which provide a horizontal surface with which a cat may interact have not heretofore facilitated or enabled a cat to interact with these structures from below or to engage in back-dragging (described above). Common examples of structures with such horizontal surfaces are:

stepped structures (e.g., U.S. Pat. No. D383,261 issued to Karsten et al, 1997), which are designed for interaction from above and in some cases may even block access from below;

structures with resting shelves (e.g. U.S. Pat. No. 5,875,735 issued to Bradley and Bradley, 1999), wherein the shelves are designed to support a cat on the top side and are often too high off the ground for interaction from below; and

structures with stabilizing horizontal members wherein the horizontal members are too high off the ground for interaction from below (e.g. U.S. Pat. No. 5,577,466 issued to Luxford, 1996), or in which the horizontal members are too low for an average cat to play comfortably underneath (e.g. U.S. Pat. Des. 370,093 issued to DeLuca, 1996).

All these structures, while they may have a low, horizontal member, are encumbered with a variety of other members which inhibit or distract from a cat's upside-down interaction (back-dragging) with the low, horizontal member and make the piece unnecessarily large and heavy.

Grooming arches (e.g., U.S. Pat. D506,582 issued to Madden, 2005) are one of the few devices specifically designed to enable a cat to interact with the underside of the device. Yet grooming arches cannot be prior art since their form and function are so different from the invention under consideration.

A few ramp-type structures have low, horizontal members and can be considered prior art. These devices are not specifically intended to enable or facilitate interaction from below, and they do not satisfactorily enable a cat to engage in the upside-down behavior (back-dragging) described above.

U.S. Pat. No. 4,112,873 (Animal Climbing Structure Kit), issued to Van Zandt in 1978, describes a ramp-like climbing device for animals, including cats. This device comprises an elongated beam member which is mounted on an upright column member at one end (the high end) and rests directly upon a base member at the other end (the low end, which basically rests upon the ground).

A cat cannot back-drag at the low end of the beam member of Van Zandt's device because there is not enough vertical clearance. The cat might not be able to back-drag at the high end of the beam, because the cat's legs might not be long enough to reach the high end of the beam. Even if this beam were adjusted to a suitable height, a cat would still be inhibited in back-dragging at the high end of the beam because it would hit its head against the supporting column member at the high end.

Three other ramp-like structures suffer from limitations similar to those described for the Van Zandt device. These are: Foreign Patent GB2295760A (Log Cat Scratch, United Kingdom, 1996), U.S. Pat. D440,717 S (Pet Ramp) issued to Fazio in 2001, and U.S. Pat. No. 3,159,141 (Pet Exerciser) issued to Paterek in 1964.

U.S. Pat. No. D269,821 (Combined Cat Playground and Exerciser), issued to Hurley in 1983, describes a device which has the shape of the capital letter “A”. There is a base which rests upon the floor; two slanting vertical members rise upward from the base until they intersect with one another. One slanting vertical member is longer than the other, and extends beyond the intersection. Between the base and the intersection of the two slanting vertical members, there is a low horizontal member (like a shelf) which extends from the inner side of one slanting vertical member to the inner side of the other.

A cat attempting to back-drag along the low horizontal member of this structure will hit its head against the slanting vertical members at either end. Additionally, a cat interacting with the low, horizontal member from below and assuming an orientation perpendicular to the horizontal member while pulling itself across the width of the horizontal member rather than along the length of the horizontal member, will be inhibited in this movement by the edge of the base, which presents both an upward obstacle at one side and a downward drop at the other side. These edges could be injurious to the back of the cat. The upper part of the structure does not contribute to back-dragging and creates additional bulk and weight.

U.S. Pat. No. 4,790,265 (Cat scratching post and exercise center), issued to Manson in 1988, describes a device comprising a base which rests upon the floor: two round vertical posts, parallel to one another, are affixed to the base and rise vertically upward a distance of several feet. The base and the posts are covered with carpet. A horizontal member (a cylindrical crossbar) is mounted to the top end of each post and spans horizontally between the posts. A toy on a string can be hung from this horizontal member for the cat to swat at.

This structure specifically enables a cat to interact with a horizontal member from below, but back-dragging is out of the question. The horizontal member is to be placed at the top of the climbing posts so that the cat “after climbing one post can walk across the bar from post to post.” Thus access to this horizontal member can be achieved only after the cat has climbed one of the posts and not while the cat is on the floor.

A weak argument can be made to consider U.S. Pat. No. D370,093 (Pet furniture) issued to DeLuca in 1996, as prior art. Although the device is quite dissimilar to the present invention in appearance, it does include a low, horizontal shelf member. (An internet search of “cat furniture” will reveal a number of devices with low, horizontal shelf members similar to the one in the DeLuca device.) Assuming that a cat can get underneath the low horizontal member to engage in back-dragging, the travel for this activity will be somewhat limited. The edges of the base may present hazards and impediments, as described for the Hurley device. In general, this device (and others like it) is not optimized to facilitate back-dragging and the other forms of interaction which will be presently described for the current invention.

### SUMMARY

In accordance with one embodiment, a horizontal exercise and scratching device for felines comprises a beam which is substantially parallel to the floor and at such a distance from the floor that a cat lying on its back beneath the beam can reach up and grasp the beam with its feet and claws. The beam is supported in such a manner that, as a cat slides on its back across the floor using the beam to pull itself along, the cat does not encounter any obstacle, thus allowing the full length of the underside of the beam to be traversed. In addition to this unique form of interaction, a number of other cat interactions with the beam are possible, as described below. Because of its size and proximity to the ground, the device is accessible and attractive to older and infirm cats as well as healthy cats.

### DRAWINGS—FIGURES

FIG. 1 is a perspective view of a first embodiment of my invention, seen along its long axis and from slightly above.

FIG. 2 is a partial exploded view of a first embodiment, showing the joint between one vertical support and the beam.

FIG. 3 is a perspective view of a second embodiment of my invention, seen along its long axis and from slightly above.

FIG. 4 is a partial exploded view of a second embodiment, showing the beam, a crosspiece, a vertical support and a foot, seen from below the beam.

FIG. 5 shows how an embodiment might be used by two cats.

FIG. 6 is a side view of a third embodiment of my invention.

FIG. 7 is a partial exploded view of a third embodiment, showing the means employed for joining the head and neck to the beam.

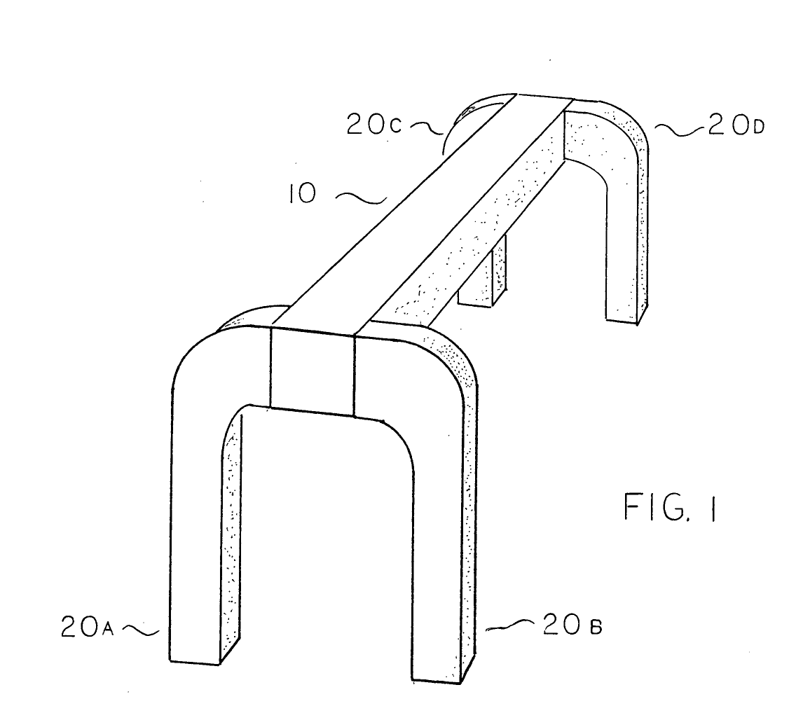

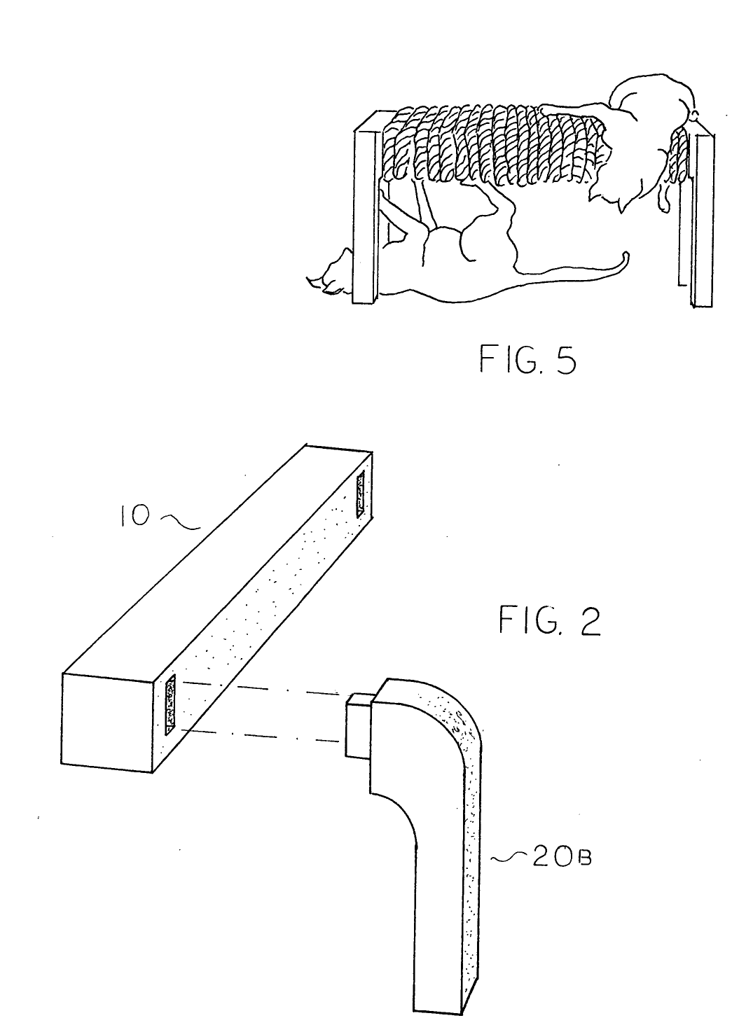

### DETAILED DESCRIPTION—FIRST EMBODIMENT—FIGS. 1 and 2

FIG. 1 shows a perspective view of a first embodiment of my cat exercise and scratching device, seen from one end and from slightly above and to one side. The device presents a beam 10. Each end of the beam is fixedly mounted to two vertical supports (20A and 20B at one end of the beam, and 20C and 20D at the other end of the beam). The vertical supports are affixed to the lateral faces of the beam, thus comprising two pairs of left and right vertical supports.

The beam in the first embodiment is rectangular in cross section. The minimum width of the beam is such that an adult housecat of average size can comfortably and safely sit on top of the beam. The maximum width of the beam is constrained by both the width and depth of the beam, such that an average adult housecat on top of the beam and hanging over the side of the beam (as shown in FIG. 5), can look underneath the beam to see its own tail hanging down the opposite side of the beam. This constraint upon the width of the beam serves both to enable the cat to play with its own dangling tail and to keep the beam to a size which will entertain the cat's sense of balance.

The minimum length of the beam in the first embodiment is a length sufficient to support the length of an average adult housecat. There is no maximum length to the beam, although the practicalities of manufacture and accommodating the beam in the home may suggest limits.

The material of the beam in the first embodiment should be rigid enough to support the weight of an average adult housecat. It should provide a secure surface for a cat to walk upon and a suitable surface on which a cat can sharpen its claws. Natural wood is an excellent, though not the only possible, material for the beam.

The vertical supports (20A, B, C, and D of FIG. 1) are of a material sufficiently rigid to hold up the beam. The bottom of each vertical support rests on the ground, floor, or other surface. The upper end of each vertical support is fastened to one of the lateral faces of the beam. FIG. 2 is an exploded view of one vertical support attached to the beam in a substantially perpendicular orientation by means of a mortise and tenon joint. FIG. 2 shows the tenon cut on the narrow face of one vertical support near the top end of the vertical support. FIG. 2 also shows the mortises on one lateral face of the beam. The mortises are cut into the beam as close to the ends of the beam as is feasible and sound. All four mortise and tenon joints should be glued to create a permanent bond.

The height at which the vertical supports are attached to the beam can be determined from the following considerations:

1) the minimum height should be such that the distance from the bottom face of the beam to the supporting surface (ground) is sufficient to allow an average adult housecat to crawl beneath the beam, and

2) the maximum height should be such that the distance from the bottom face of the beam to the supporting surface is the same as the height of an average adult housecat at the head. This distance allows a cat lying on its back with its legs at maximum extension to engage its claws with the bottom face of the beam.

Another important consideration is the clearance between the vertical supports at each end of the beam. In FIG. 1, this clearance is found between vertical supports 20A and 20B, and between 20C and 20D. The clearance should be sufficient to allow an average adult housecat to pass between the vertical supports, yet small enough so that the cat can grasp one or both vertical supports with its paws in order to pull itself through the gap. Thus the minimum clearance should be the width of the beam itself, and the maximum clearance would be roughly equal to twice the height of an average adult housecat at the shoulder.

### Operation—First Embodiment

The horizontal exercise and scratching beam is placed on the floor or other surface. One or more cats can then interact with the device in the following ways (several of which are shown in FIG. 5):

1. a cat (or several cats) can lie on its back beneath the beam and engage its claws in the underside and/or the sides of the beam.

2. with its claws engaged in the underside and/or sides of the beam, a cat (or several cats) can drag itself along the floor on its back (back-dragging). The cat can continue this motion until it emerges through the gap between the vertical supports at either end of the beam.

3. a cat (or several cats) can lie down, sit, stand, or walk on the top side of the beam. It can jump up onto the beam and down again. While so interacting with the top of the beam, the cat can frolic in ways that test its balance and ability to remain on top of the beam.

4. a cat (or several cats) can lie crosswise across the top side of the beam and reach underneath the beam to swat at its own tail, which it can see hanging down the opposite side of the beam.

5. while standing on top of the beam, a cat (or several cats) can sharpen its claws. Claws can also be sharpened while a cat is not mounted on the beam.

6. a cat can position itself on top of the beam while another cat lies upside-down beneath the beam. In this configuration, very similar to one that cats naturally adopt in playing, the two cats can swat playfully at one another. In particular, the cat on the bottom can swat at the tail of the cat on top.

7. two or more cats can play hide and seek or swat at one another through the gap between the vertical supports at either end.

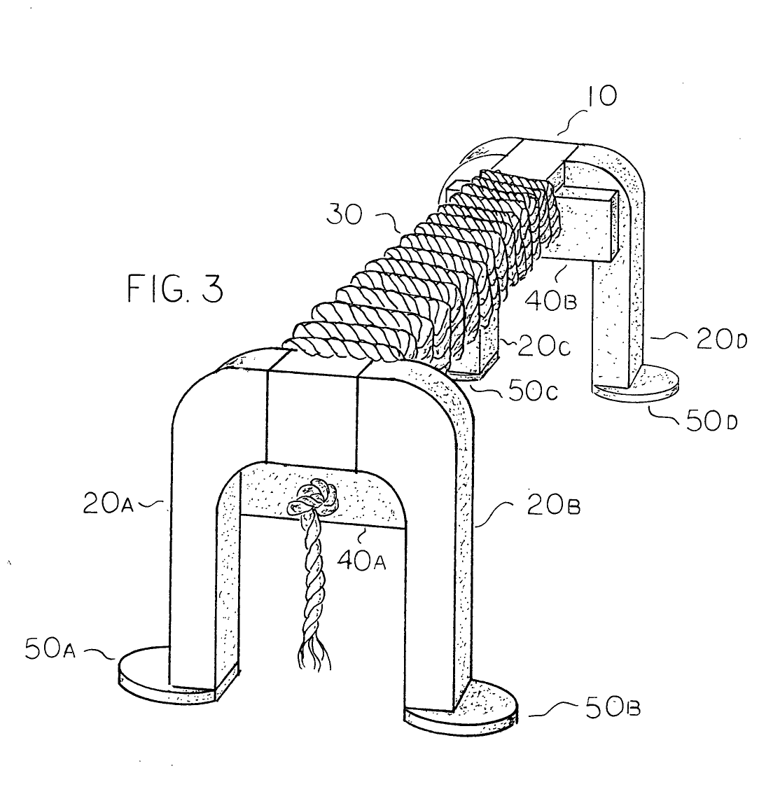

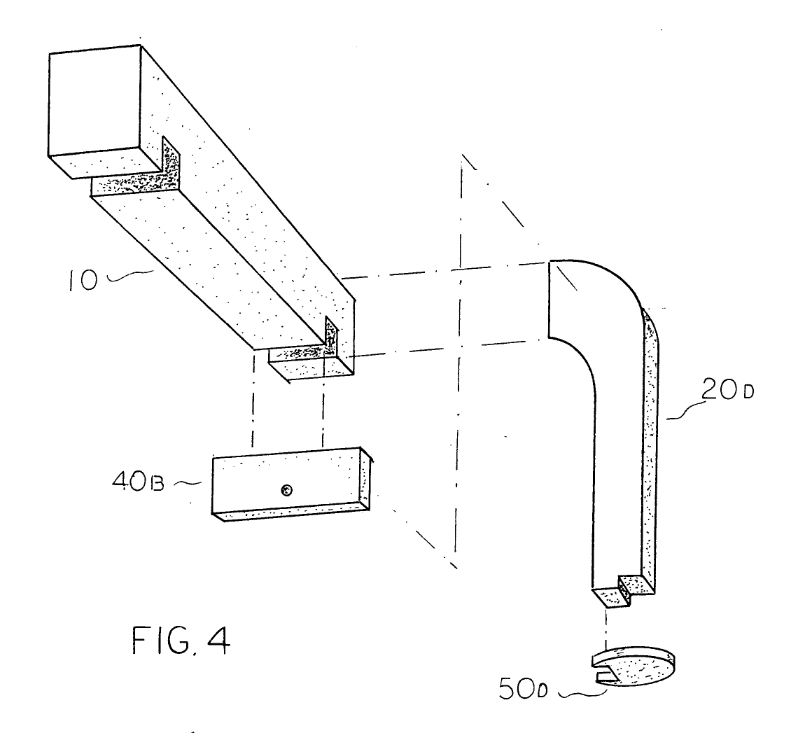

### Description—The Second Embodiment—FIGS. 3 and 4

FIG. 3 shows a perspective view of a second embodiment of the horizontal exercise and scratching beam. In the second embodiment, a beam 10 differs from the beam of the first embodiment in that it does not have any mortises. As shown in FIG. 4, a notch is cut crosswise across the bottom face of the beam near either end (two notches total). Each notch is of exact width to accept a crosspiece 40A or 40B and of a depth to partially accept such crosspiece.

The beam should provide a secure surface for a cat to walk upon in case the wrapping (discussed below) comes off of the beam (for instance, the beam material should not be slippery). The beam material should also be such that the wrapping remains firmly attached (does not slip on the beam when a cat claws at it). Natural wood is an excellent, though not the only possible, material for the beam.

Two crosspieces 40A and 40B have a rectangular shape. The crosspieces are made of a rigid material (it can be the same material as the beam). Each crosspiece is of exact thickness to fit into one of the notches cut crosswise into the bottom face of the beam. Each crosspiece is centered upon and fitted into one of the notches in the underside of the beam. These joints are glued to create a permanent bond.

The length of each crosspiece is sufficient to span the width of the beam and extend beyond the beam on either side. Each crosspiece should extend beyond the beam far enough to present adequate gluing or fastening surface to the back faces of vertical supports 20A and B and 20C and D. A hole is drilled through the thickness of one cross piece in the center and near the lower edge of the cross piece. This hole is of sufficient size to allow the wrap (discussed below) to pass through it.

The vertical supports of the second embodiment, as shown in FIG. 4, differ from the vertical supports of the first embodiment in that they do not have a tenon. The back or inside face of each vertical support sits flush against an extension of one of the crosspieces and is glued and/or screwed to the crosspiece.

A notch cut into the bottom of each vertical support is adapted to mate with one of four feet 50A, B, C, and D. The feet can be made of the same material as the beam and are substantially round in shape. A notch cut into each foot accepts the notched end of one of the vertical supports. These joints are glued to create a permanent bond. When attached to the vertical supports, the feet provide additional stability and resemble the paws of an animal, providing visual interest for the pet owner.

The beam is covered with a wrapping 30 that will both attract cats to scratch upon it and will retain its integrity under repeated scratching. Sisal rope is an excellent, though not the only possible, material for the wrapping. One end of the rope is fastened to the bottom face of the beam, at the end where the crosspiece does not have a hole in it. This fastening can be effected by means of staples or other conventional fastener. The rope is then wrapped around the beam so that each turning covers each of the four beam faces in sequence. The first such turning of the rope is inside the surface presented by the crosspiece. Each turning of the rope is applied adjacent to the last, so that no portion of the beam remains exposed, and with sufficient tension so that the rope more or less continuously touches the surface of the beam and cannot be pulled away from the beam using pressures which might be exerted by an average adult housecat. The turnings of the rope continue until the crosspiece at the opposite end of the beam is reached. There the free end of the rope is passed through the hole in the crosspiece and knotted on the outer side of the hole with a knot large enough that it cannot pull through the hole. The remaining length of rope may then be allowed to dangle, providing additional entertainment for one or more cats. The tail-like appearance of the dangling rope provides visual interest for the pet owner.

### Operation—Second Embodiment

The operation of the second embodiment includes all the operations of the first embodiment, and in addition provides a cat with the dangling end of the rope to swat at or chew.

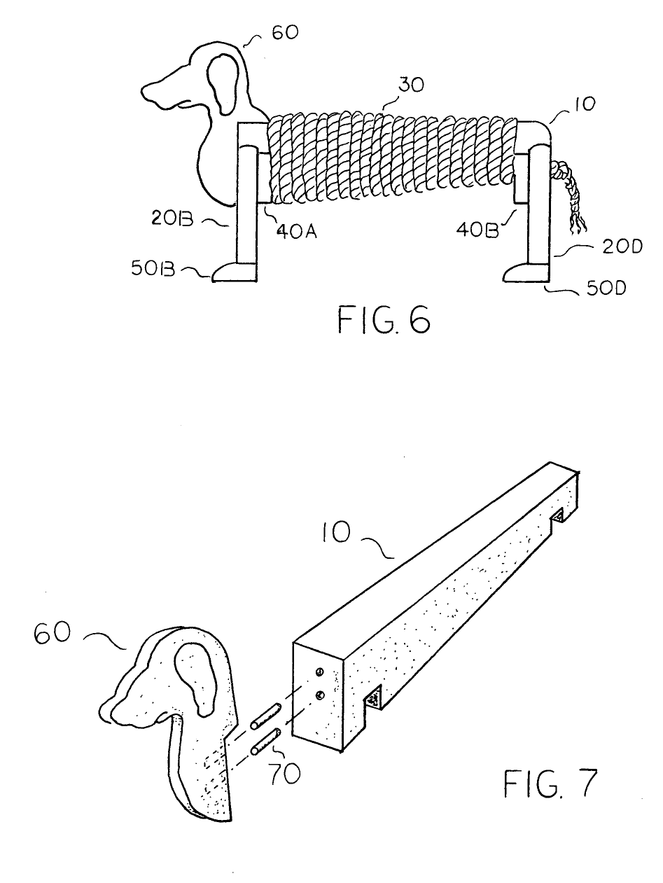

### Description—The Third Embodiment—FIGS. 6 and 7.

FIG. 6 is a side view of a third embodiment. A beam 10 varies in depth from one end of the beam to the other. At the end where the head (discussed below) will be attached, the beam is of the same depth or even greater depth than in the first or the second embodiment. At the tail end of the beam, the depth is substantially less than at the head end. The bottom face of the beam thus slopes upward from the head end to the tail end of the beam, while still respecting the requirements described in the first embodiment concerning minimum and maximum height. The narrower end of the beam may be rounded somewhat to further the resemblance to an animal. Two holes are bored into the head end of the beam, as described below.

Vertical supports 20A (not shown in FIG. 6), 20B, 20C (not shown) and 20D are attached to the beam either as in the first embodiment or the second embodiment. The vertical supports terminate in feet 50A (not shown in FIG. 6), 50B, 50C (not shown) and 50D as in the second embodiment.

A wrapping 30 substantially covers the beam, as in the second embodiment.

A neck and head piece 60 is shaped to resemble the neck and head of an animal, in this case a dog. The neck and head are made of a rigid material that is safe and non-toxic for cats. It can be made of the same material as the beam, in which case it will be susceptible to clawing by the cat, or it can be something more durable, provided it is does not harm the cat's claws if the cat attempts to scratch it. The neck and head may be painted or sculpted in relief, have cloth ears attached, and so forth, to further the resemblance to an animal.

Although various methods of joining the neck and head to the beam may be practical, FIG. 7 shows the neck and head piece cut to a thickness which may then be penetrated by round bores. The round bores are adapted to receive the ends of two pieces of dowel 70. Two matching holes bored into the head end of the beam receive the other ends of the dowel. For more stability, a notch in the lower neck sits over the top face and front end of the beam. Glue is applied to all the bores, the dowel, and the mating faces of the neck and beam to create a permanent bond.

Great variety and imagination may be exercised in shaping the neck and head, yet consideration must be given to the overall balance and stability of the device. That is, if a cat standing upon the beam puts its front paws up on the head or neck, or attempts to climb the head or neck, the device should not tip over. This stability can be achieved by keeping the neck and head low or by increasing the length and/or weight of the beam.

### Operation—Third Embodiment

The operation of the third embodiment is similar to the operation of the second embodiment.

### Advantages

From the description above, a number of advantages of some of the embodiments of my horizontal exercise and scratching beam for felines become evident:

(a) The device enables and entices cats to play by turning upside-down and dragging themselves along the floor on their back. Cats can use the full length of the device for this behavior without risk of hitting their heads on obstacles or pulling their spines over potentially harmful edges.

(b) Because cats naturally interact with one another by playing in a configuration with one cat on its back and another cat upright or on top of it, the device encourages interaction between cats. This can be a great help in households where there are cats who do not get along. It also provides stimulating play opportunities for cats who do get along.

(c) Because cats naturally and spontaneously play in the manner described in (a), they are attracted to the device and thereby encouraged to sharpen their claws upon it. This assists in integrating cats harmoniously into households where a cat may be tempted to sharpen its claws on inappropriate items (such as upholstered furniture).

(d) The device also creates interest and attracts cats by providing a challenge to a cat's sense of balance. Furthermore, it does this in a safe way, unlike some devices which challenge a cat's sense of balance by requiring it to climb up a pole or ramp to an elevated platform.

(e) Because the device is so close to the ground, it is far safer for cats than some other cat exercise or entertainment devices. An older or infirm cat that is not able to make use of other devices may find this one accessible. There is no danger of a cat falling from such a height that it can be injured.

(f) The scratching surface of the device is very stable, unlike some upright scratching posts mounted on a base. Yet it provides far more interest than some horizontal scratching devices, which are often rather two-dimensional and provide no other interest or means of interaction for the cat. (For an example of a typical horizontal scratching device, see U.S. Pat. No. 7,117,821 issued to Novak in 2006. For an upright post on a base, see U.S. Pat. No. 6,490,996 issued to Terry in 2002. Upright scratching surfaces are often attached to larger household fixtures to increase stability, as in U.S. Pat. No. 6,343,569 issued to Buendiger in 2002.)

(g) The device is both portable and small, which is of great convenience to pet owners who live in small quarters or who want to be able to move their cat's toys when company comes over, etc.

(h) The wrapping can be replaced after it has become worn and frayed, thus renewing the appearance of the device.

The foregoing are some of the advantages evident from some of the embodiments of my invention. However, the scope of the invention should be determined by the appended claims and their legal equivalents, and not by the advantages given.

### Conclusion, Ramifications, and Scope

Accordingly the reader will see that the various embodiments of my invention provide significant exercise, play and claw-sharpening opportunities for felines. While the description contains many specificities, these should not be construed as limitations on the scope of any embodiment, but merely as exemplifications of the various embodiments. Many other ramifications and variations are possible within the teachings of the various embodiments. For example:

the color and appearance of the wrapping, the shape of the legs and feet, and the kind and color of wood used, may be varied to make the device more suitable to fit with the decor favored by a given pet owner.

a variety of standard wood joinery techniques can be used instead of a mortise and tenon to join the vertical supports to the beam, and/or the joints can be effected or reinforced with brackets or other conventional fasteners.

different materials can be used for the beam, vertical supports, cross pieces, feet, and neck and head, such as man-made woods, metals, fabrics, and/or plastics. Joining methods would then be modified as appropriate to the materials used. In fact, some manufacturing methods might obviate the need for a means of joining the parts. For example, the beam, vertical supports, feet, and/or head could be cast of one continuous piece of plastic, which is then wrapped or covered to provide a suitable scratching surface.

the wrap could be a rope other than sisal rope. Carpet or any other material that presents a suitable and sturdy scratching surface that can be attached to a beam could be used as a wrap. The wrap material can be scented with catnip to help attract a cat to the device.

two pieces of rope of contrasting color can be used to wrap the beam, providing visual interest.

the beam can be a single piece or an aggregate (composite) of smaller pieces.

the beam can be round or square, hollow or solid. It could even be triangular in cross section, so long as it is oriented to present a flat surface on the top side of the beam and the vertical supports at either end have adequate clearance between them.

the beam can be angled slightly or curved or peaked so long as the minimum and maximum height of the beam are in accordance with the requirements stated in the claims.

the vertical supports can be placed so that a length of beam is left to extend beyond them. That is, the vertical supports do not have to be placed at the end of the beam, so long as they are placed to ensure stability.

the crosspiece and vertical supports of the second embodiment may be constructed of a single piece, that is, a cross piece with two appendages that serve as vertical supports.

one or more extra vertical supports may be used to support the beam, which is particularly desirable if the beam is long.

the vertical supports can be shaped so as to further the visual likeness of the device to various animals. For example, the legs could be shaped like those of a grasshopper or a spider, with the beam substantially suspended from them.

various means for attaching a neck and head to the beam can be employed, for example: mortise and tenon, tongue and groove and other standard woodworking joints; also brackets, screws and other conventional fasteners; also glue and other conventional adhesives. Depending on the materials employed, the beam, head, and the neck might be one piece.

the proportions of the device, instead of being based on the size of an average adult housecat, can be based on those of a kitten or of a larger feline. Proportions might be altered to suit a particular breed, e.g., the Munchkin, which has very short legs.

two or more of these devices may be used in conjunction, with the beams mounted at different heights. This creates additional interest and play opportunities for cats. In such an embodiment, the structures might be physically linked together to hold the combined devices in the desired configuration.

because it is simple to put together, the device can be marketed in its unassembled state, as a kit. This has the further advantage of reducing shelf space for retailers who sell the kit.

Thus the scope of the invention should be determined by the appended claims and their legal equivalents, and not by the examples given.

I claim:

1. A horizontal exercise and scratching beam device for felines comprising:
(a) a beam having a top face, a first lateral face, a bottom face, a second lateral face, a first end and a second end; the width of said top face at least equal to the approximate abdominal width of the average housecat and not exceeding approximately one and a half times the abdominal width of an average housecat; the circumference of said beam measured around said top face, said first lateral face, said bottom face and said second lateral face not exceeding five times said width of said top face; the length of said beam at least approximately as long as an average housecat from shoulders to hips; said beam made of a material firm enough to support an average housecat and which can to some degree be penetrated by the claw of an average housecat;
(b) a plurality of vertical support members;
(c) a means for attaching said vertical support members in a substantially perpendicular orientation to said beam, so as to support said beam in a substantially horizontal orientation above a supporting surface; the distance between said bottom face of said beam and said supporting surface being at least equal to the approximate height of an average housecat at the knee and not exceeding the approximate height of an average housecat at the head; said vertical support members positioned so as to leave an unobstructed pathway beneath said beam;
whereby a feline can play and exercise in various ways including but not limited to lying on its back underneath said beam, grasping said beam with its claws, and playfully pulling itself along the full length of said bottom face of said beam on its back.

2. The horizontal exercise and scratching beam device for felines of claim 1 wherein said means for attaching said vertical support members to said beam comprises any of a common kind of joint, such as mortise and tenon, dovetail, lap, rabbet, groove and the like.

3. The horizontal exercise and scratching beam device for felines of claim 1 wherein said means for attaching said vertical support members to said beam comprises any of a common kind of fastener, such as a bracket and screws, screws, dowels, nails, glue, and the like.

4. The horizontal exercise and scratching beam device for felines of claim 1 further including a wrap which substantially covers all faces of said beam, said wrap being made of a material which can to some degree be penetrated by the claw of an average housecat.

5. The horizontal exercise and scratching beam device for felines of claim 4 wherein said wrap is made of flexible sheet material.

6. The horizontal exercise and scratching beam device for felines of claim 4 wherein said wrap is made of flexible line material.

7. The horizontal exercise and scratching beam device for felines of claim 1 further including a plurality of feet attached to the lower ends of said vertical support members.

8. The horizontal exercise and scratching beam device for felines of claim 1 further including a neck and head shaped to emulate an animal, real or imaginary, and a means for attaching said neck and head to said beam, whereby the visual appeal of the device and its overall resemblance to an animal is enhanced.

9. The horizontal exercise and scratching beam device for felines of claim 1 wherein the dimensions and proportions are uniformly scaled to accommodate use by a feline smaller than the average housecat, a feline larger than the average housecat, or a particular breed of feline.

10. The horizontal exercise and scratching beam device for felines of claim 1 wherein all the parts thereof are unassembled, and whereby the device can be distributed as a kit for later assembly.

11. The horizontal exercise and scratching beam device for felines of claim 1 further including
(a) a wrap which substantially covers all faces of said beam, said wrap being made of a material which can to some degree be penetrated by the claw of an average housecat,
(b) a plurality of feet attached to the lower ends of said vertical support members, and
(c) a neck and head shaped to emulate an animal, real or imaginary, and a means for attaching said neck and head to said beam.

12. A horizontal exercise and scratching beam device for felines comprising:
(a) a beam having a top face, a first lateral face, a bottom face, a second lateral face, a first end and a second end; the width of said top face at least equal to the approximate abdominal width of the average housecat and not exceeding approximately one and a half times the abdominal width of an average housecat; the circumference of said beam measured around said top face, said first lateral face, said bottom face and said second lateral face not exceeding five times said width of said top face; the length of said beam at least approximately as long as an average housecat from shoulders to hips; said beam made of a material firm enough to support an average housecat and which can to some degree be penetrated by the claw of an average housecat; said beam penetrated by a plurality of notches cut across the width of said bottom face;
(b) a plurality of vertical support members;
(c) a plurality of crosspieces, adapted to fit lengthwise into said notches in said beam and of such length that when centered in said notches, each said crosspiece extends beyond said lateral faces of said beam;
(d) said vertical support members attached to said crosspieces in a substantially perpendicular orientation to said beam, so as to support said beam in a substantially horizontal orientation above a supporting surface; the distance between said bottom face of said beam and said supporting surface being at least equal to the approximate height of an average housecat at the knee and not exceeding the approximate height of an average housecat at the head; said vertical support members positioned so as to leave an unobstructed pathway beneath said beam;
whereby a feline can play and exercise in various ways including but not limited to lying on its back underneath said beam, grasping said beam with its claws, and playfully pulling itself along the full length of said bottom face of said beam on its back.

13. The horizontal exercise and scratching beam device for felines of claim 12 further including a wrap which substantially covers all faces of said beam, said wrap being made of a material which can to some degree be penetrated by the claw of an average housecat.

14. The horizontal exercise and scratching beam device for felines of claim 13 wherein said wrap is made of flexible sheet material.

15. The horizontal exercise and scratching beam device for felines of claim 13 wherein said wrap is made of flexible line material.

16. The horizontal exercise and scratching beam device for felines of claim 12 further including a plurality of feet attached to the lower ends of said vertical support members.

17. The horizontal exercise and scratching beam device for felines of claim 12 further including a neck and head shaped to emulate an animal, real or imaginary, and a means for attaching said neck and head to said beam, whereby the visual appeal of the device and its overall resemblance to an animal is enhanced.

18. The horizontal exercise and scratching beam device for felines of claim 12 wherein the dimensions and proportions are uniformly scaled to accommodate use by a feline smaller than the average housecat, a feline larger than the average housecat, or a particular breed of feline.

19. The horizontal exercise and scratching beam device for felines of claim 12 wherein all the parts thereof are unassembled, and whereby the device can be distributed as a kit for later assembly.

20. The horizontal exercise and scratching beam device for felines of claim 12 further including
(a) a wrap which substantially covers all faces of said beam, said wrap being made of a material which can to some degree be penetrated by the claw of an average housecat,
(b) a plurality of feet attached to the lower ends of said vertical support members, and
(c) a neck and head shaped to emulate an animal, real or imaginary, and a means for attaching said neck and head to said beam.
